(19) United States
(12) Patent Application Publication
(10) Pub. No.: US 2014/0044287 A1
(43) Pub. Date: Feb. 13, 2014

(54) FLAT TYPE SPEAKER HAVING DAMPER-LEAD PLATE OF PCB VOICE COIL PLATE

(71) Applicants: Dong-Man Kim, Seoul-si (KR); Yong-Ji Kwon, Seoul-si (KR)

(72) Inventors: Dong-Man Kim, Seoul-si (KR); Yong-Ji Kwon, Seoul-si (KR)

(73) Assignee: EXELWAY INC., Seoul (KR)

(21) Appl. No.: 13/985,169

(22) PCT Filed: Feb. 13, 2012
(86) PCT No.: PCT/KR2012/001037

§ 371 Date: Oct. 21, 2013

(30) Foreign Application Priority Data
Feb. 16, 2011 (KR) 10-2011-0013776

(51) Int. Cl. H04R 19/02

(52) U.S. Cl. CPC H04R 19/02
USPC 381/191

(57) ABSTRACT

The present invention relates to a flat type speaker, and more particularly, to a flat type speaker having a damper-lead plate of a PCB voice coil plate, which improves the quality deterioration due to the reduction of production process and the disconnection of a lead wire, by being attached to the top of a voice coil plate, increases vibration efficiency, and eliminates the lead wire connection of the voice coil. The flat type speaker having a damper-lead plate of a PCB voice coil plate according to the present invention comprises: a pair of magnetic bodies having a magnet and a yoke formed side by side, separated at a predetermined interval; a voice coil plate inserted in the space between the magnetic bodies, and having formed thereon a voice coil with a spiral pattern printed thereon; a damper-lead plate having a first damper-lead plate and a second damper-lead plate, which are physically separated, each having +, − terminals formed on the front ends thereof, wherein the first and the second damper-lead plates are each equipped with a coil plate spline, which adheres to the upper end of the voice coil plate, and at least one wing spline having one end thereof connected to the coil plate spline and the other end connected to the + or − terminals; and a vibration plate, which vibrates from the vibration received from the voice coil plate, while being contacted to the upper end portion of the damper-lead plate.

### TECHNICAL FIELD

The present invention relates to a flat type speaker and, more particularly, to a flat type speaker having damper-lead plates for a PCB voice coil plate, which can improve vibration efficiency by mounting the damper-lead plates on the top of the voice coil plate, reduce a production process by eliminating lead wires connected to a voice coil, and improve the deterioration of quality due to the disconnection of a lead wire.

### BACKGROUND ART

A speaker is equipped with a voice coil and a vibration plate interposed between magnets, and the speaker generates sound when the vibration plate is vibrated by a movement of the voice coil.

A flat type speaker includes a flat type voice coil and magnets disposed on both sides of the flat type voice coil and spaced apart from each other at a specific interval. In this flat type speaker, induced electromotive force is generated according to Fleming's left-hand law and Lorentz's force, a frequency according to a voice is formed, and the frequency vibrates the vibration plate, thereby being reproduced into sound.

The voice coil is wound in an oval form or patterned and printed on one or both sides of a plate type coil base, thus forming a voice coil plate.

A vibration plate is attached to the top of the voice coil plate in a length direction. The vibration plate is vibrated in response to a movement of the voice coil plate, thereby generating sound.

Furthermore, the voice coil formed in the voice coil plate is bonded to both terminals of a base frame that forms the outside of + and − lead wires, thereby forming a circuit.

In a conventional voice coil plate, however, a contact area with the vibration plate is small because the voice coil plate is adhered to the vibration plate in an upright state. As a result, the transfer of vibration energy is limited.

Furthermore, since the lead wires formed in the voice coil plate are bonded to the base frame, a problem in which the bonding is broken because the voice coil plate is moved up and down, but the base frame is fixed is frequently generated.

Furthermore, in general, the lead wires of the voice coil plate are connected to the terminals of the base frame using a soldering method, but this method is problematic in that the quality of the speaker is deteriorated.

### DISCLOSURE

### Technical Problem

Accordingly, the present invention has been made to solve the conventional problems, and an object of the present invention is to transfer more sound energy by connecting damper-lead plates between a vibration plate and a PCB voice coil plate.

Another object of the present invention is to reduce a manufacturing process by eliminating a problem in which lead wires are connected by soldering for electrical connection from a voice coil to the terminals of a base frame and to solve a quality deterioration problem attributable to the connection of the lead wires.

### Technical Solution

To achieve the above objects, a flat type speaker having damper-lead plates for a PCB voice coil plate according to the present invention includes a pair of magnetic bodies spaced apart from each other at a specific interval, formed side by side, and each having a magnet and yorks formed therein; a voice coil plate inserted into an interval between the magnetic bodies and having a voice coil spirally patterned and printed formed therein; damper-lead plates including first and second damper-lead plates physically separated and having + and − terminals formed at the respective front ends of the damper-lead plates, wherein each of the first and the second damper-lead plates includes a coil plate spline adhered to the top of the voice coil plate and one or more wing splines having one end connected to the coil plate spline and the other end connected to the + or − terminal; and a vibration plate vibrated in response to the vibration of the voice coil plate with the vibration plate coming in contact with a top of the damper-lead plates.

Here, the wing splines preferably are implemented so that they are brought in contact with a bottom of the vibration plate.

Here, the first and the second damper-lead plates may be made of conductive and metallic materials, and the second damper-lead plate may be symmetrical to the first damper-lead plate and rotated by 180 degrees from the first damper-lead plate.

Here, the first and the second damper-lead plates may be made of insulating materials and formed of one body, and the first and the second damper-lead plates may be coated with conductive materials in such a way as to be electrically separated.

Each of the first and the second damper-lead plates preferably may include a lead block connected to the front end of the voice coil by soldering at a front end on one or the other side of the coil plate spline or at front ends on both sides of the coil plate spline.

The width of the coil plate spline preferably may be smaller than or equal to the thickness of the voice coil plate, and the width of the lead block preferably may be greater than the width of the coil plate spline.

### Advantageous Effects

In accordance with the construction of the present invention, more sound energy can be transferred by connecting the damper-lead plates between the vibration plate and the PCB voice coil plate, and the process can be reduced and a quality deterioration problem attributable to the connection of lead wires can be solved by eliminating a problem in which the lead wires are connected by soldering for electrical connection from the voice coil to the terminals of a base frame.

### DESCRIPTION OF DRAWINGS

FIG. 1 is a perspective view of a flat type speaker having damper-lead plates for a PCB voice coil plate according to the present invention.

FIG. 2 is an exploded perspective view of the flat type speaker having damper-lead plates for a PCB voice coil plate according to the present invention.

FIG. 3 is a perspective view of a coupling structure between the PCB voice coil plate and the damper-lead plates according to the present invention.

FIG. 4 is a perspective view of the damper-lead plates according to the present invention.

| | |
|---|---|
| 110: voice coil plate | 110a: voice coil |
| 111: magnetic body | 112: damper-lead plate |
| 112a: first damper-lead plate | |
| 112b: second damper-lead plate | |
| 113: vibration plate | 201a, 201b: coil plate spline |
| 202a, 202b: wing spline | 203a, 203b: terminal |
| 204a, 204b, 205a, 205b: lead block | |

### MODE FOR INVENTION

Hereinafter, the construction and effects of a flat type speaker having damper-lead plates for a PCB voice coil plate according to the present invention are described with reference to the accompanying drawings.

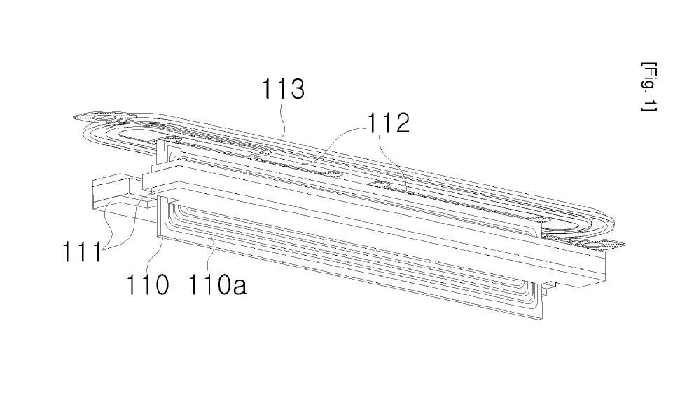

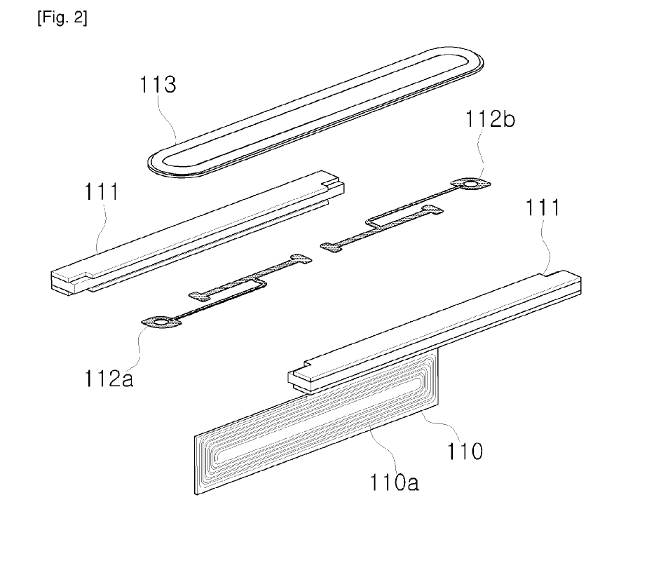

FIG. 1 is a perspective view of a flat type speaker having damper-lead plates for a PCB voice coil plate according to the present invention, and FIG. 2 is an exploded perspective view of the flat type speaker having damper-lead plates for a PCB voice coil plate according to the present invention.

As shown in FIG. 1, the flat type speaker having damper-lead plates for a PCB voice coil plate according to the present invention includes a voice coil plate 110 on which a voice coil 110a patterned and printed in a track form and formed in a Printed Circuit Board (PCB) form is patterned and printed, a pair of magnetic bodies 111 spaced apart from each other at a specific interval on the left and right of the voice coil plate 110, a pair of damper-lead plates 112 connected to the top of the voice coil plate 110 and configured to assist up and down movements of the voice coil plate 110 and to have leads electrically connected to the voice coil 110a formed therein, and a vibration plate 113 connected to the top of the damper-lead plates 112 and configured to transfer vibration energy in a sound form. The flat type speaker can further include a base frame (not shown) made of synthetic materials which forms the outside and with which various parts can be combined.

Each of the magnetic bodies 111 can include a magnet at the center thereof and yorks or magnet plates combined on and below the magnet. The pair of magnetic bodies 111 are spaced apart from each other at a specific interval and formed side by side, and the voice coil plate 110 is inserted into the interval between the formed magnetic bodies 111.

The flat type speaker of the present invention includes the voice coil plate 110 and the magnetic bodies 111 disposed on both sides of the voice coil plate 110 with a specific interval interposed therebetween. When a current flows in the voice coil, induced electromotive force is generated according to Fleming's left-hand law and Lorentz's force, and the voice coil plate 110 is moved up and down in response to the induced electromotive force.

Here, the damper-lead plates 112 formed at the top of the voice coil plate 110 are vibrated while operating in conjunction with the up and down movements of the voice coil plate 110. Accordingly, the vibration of the damper-lead plates 112 together with the vibration of the voice coil plate 110 is transferred to the vibration plate 113, with the result that more vibration can be transferred to the vibration plate 113 as compared with the case where vibration is transferred by only the voice coil plate 110.

Furthermore, as will be described later, + and − terminals are formed at both ends of the damper-lead plates 112, and thus the power wire of the voice coil 110a is connected to one side of the damper-lead plates 112 by soldering. Accordingly, the damper-lead plates 112 function as lead wires for connecting the voice coil and the + and − terminals mounted on the base frame.

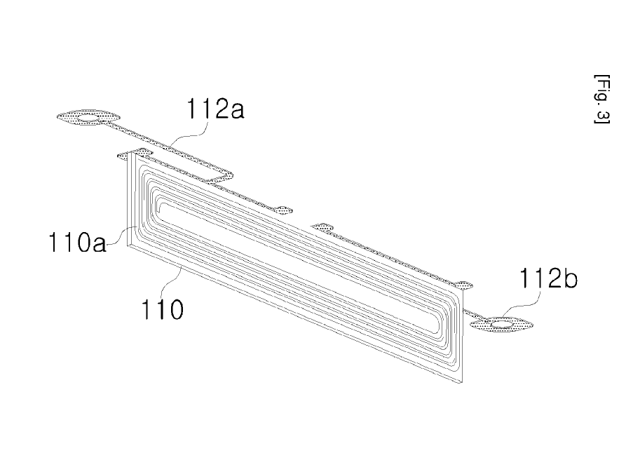

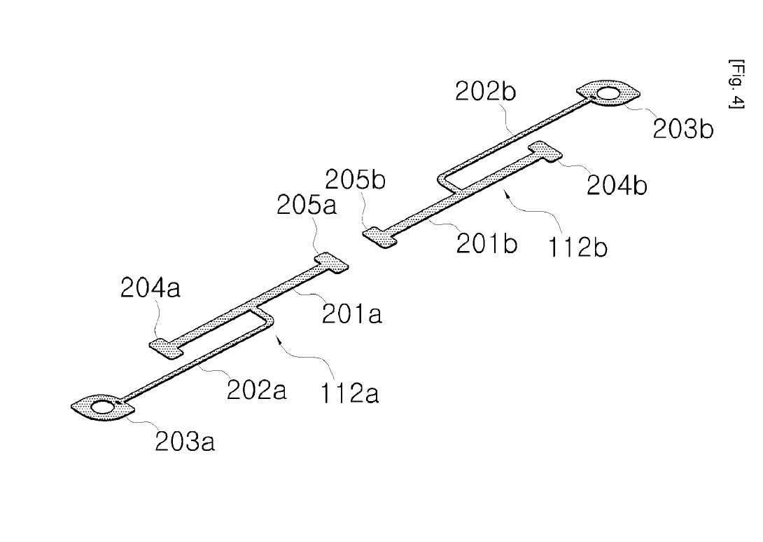

The structure of the damper-lead plates and the coupling structure between the voice coil plate and the damper-lead plates to be implemented by the present invention are described in detail below with reference to FIGS. 3 and 4.

FIG. 3 is a perspective view of the coupling structure between the PCB voice coil plate and the damper-lead plates according to the present invention, and FIG. 4 is a perspective view of the damper-lead plates according to the present invention.

The damper-lead plates 112 are connected to the top of the voice coil plate, and the damper-lead plates 112 function as sheet springs or dampers, that is, auxiliary means for transferring more vibration energy to the vibration plate. Furthermore, the terminals are formed at both ends of the damper-lead plates 112, and the damper-lead plates 112 are formed of metal plates (or formed by coating conductive materials on an insulating plate). Accordingly, soldering connection with lead wires that was used for circuit connection with an existing voice coil can be eliminated, a failure due to the disconnection of a lead wire can be prevented by replacing the role of the lead wires with the metal plates, and difficulties in the process can be solved.

Various splines that form the damper-lead plates 112 mean slim, long, and thin plates, such as metal, in a dictionary definition.

Referring to FIGS. 3 and 4, the damper-lead plates 112 according to the present invention include a pair of a first damper-lead plate 112a and a second damper-lead plate 112b on the left and right.

The first and the second damper-lead plates 112a and 112b are physically separated from each other and formed of metallic thin films having conductivity. One of the first and the second damper-lead plates 112a and 112b forms a circuit using the + terminal, and the other thereof forms a circuit using the − terminal.

For another example, the first and the second damper-lead plates 112a and 112b can be integrally formed physically and made of insulating materials. Here, the first and the second damper-lead plates 112a and 112b can be coated with conductive materials so that they are electrically separated. As a result, one of the first and the second damper-lead plates 112a and 112b can form the circuit using the + terminal, and the other thereof can form the circuit using the − terminal.

The second damper-lead plate 112b is rotated by 180 degrees from a reference line in the length direction of the speaker in the state in which the second damper-lead plate 112b is symmetrical to the first damper-lead plate 112a on the basis of a line vertical to the reference line.

The reason why the first and the second damper-lead plates 112a and 112b are symmetrical to each other left and right and up and down is to take advantages of a production process by making the first and the second damper-lead plates 112a and 112b substantially have the same structure. This reason is for equally maintaining the transfer of vibration energy to the vibration plate 113, but there is no problem although the first and the second damper-lead plates 112a and 112b have different structures.

The first damper-lead plate 112a includes a coil plate spline 201a, a wing spline 202a, a terminal 203a, and one or more lead blocks 204a and 205a, which are integrally coupled seamlessly. Likewise, the second damper-lead plate 112b includes a coil plate spline 201b, a wing spline 202b, a terminal 203b, and one or more lead blocks 204b and 205b, which are integrally coupled seamlessly.

The coil plate splines 201a and 201b are parts adhered to the top of the voice coil plate 110. The wing splines 202a and 202b are protruded from middle points of the coil plate splines 201a and 201b. The wing splines 202a and 202b come in contact with the bottom of the vibration plate 113 like dampers in a non-contact state, thus functioning to assist vibration.

The coil plate splines 201a and 201b are parts adhered to the top of the voice coil plate 110 in the state in which the voice coil plate 110 is upright. Thus, the coil plate splines 201a and 201b are lengthily formed in width that corresponds to the thickness of the voice coil plate 110.

Each of the wing splines 202a and 202b has a thin width, and the length of each of the wing splines 202a and 202b is about ½ of the flat type speaker. The front ends of the wing splines 202a and 202b on one side are connected to the respective coil plate splines 201a and 201b, and the front ends of the wing splines 202a and 202b on the other side are connected to the respective terminals 203a and 203b. The wing splines 202a and 202b function as media for electrically connecting the coil plate splines 201a and 201b and the terminals 203a and 203b and also function as vibration media for assisting the vibration of the voice coil plate 110 so that the vibration is transferred to the vibration plate 113.

The terminals 203a and 203b are parts formed at the respective front ends of the first damper-lead plate 112a and the second damper-lead plate 112b and coupled with a power terminal pole formed in the base frame (not shown). One of the terminals 203a and 203b is used as a + terminal, and the other thereof is used as a − terminal.

The lead blocks 204a, 205a and 204b, 205b are parts connected to the + and − wire parts of the voice coil 110a of the voice coil plate 110, and they function to electrically connect the voice coil 110a and the terminals 203a and 203b.

In general, a single-sided voice coil plate having the voice coil 110a printed on one side thereof or a double-sided voice coil plate having the voice coils 110a printed on both sides thereof can be used as the voice coil plate 110. For this reason, the lead blocks 204a, 205a and 204b, 205b are protruded toward both sides of the coil plate splines 201a and 201b, so that the lead blocks 204a, 205a and 204b, 205b are connected to the voice coil in either side by soldering.

Furthermore, in the case of the voice coil 110a patterned and printed on one side or both sides of the voice coil plate 110, the + and − lead wires of the voice coil 110a can be placed at front ends on both sides of the voice coil plate 110, and the + and − lead wires of the voice coil 110a can be placed at the center of the voice coil plate 110. Accordingly, the lead blocks are formed at respective front ends on both sides of the coil plate splines 201a and 201b.

That is, if the + and − lead wires of the voice coil 110a are placed at the front ends on both sides of the voice coil plate 110, the lead block 204a and the lead block 204b can be used as parts soldered to the + and − lead wires of the voice coil 110a. If the + and − lead wires of the voice coil 110a are placed at the center of the voice coil plate 110, the lead block 205a and the lead block 205b can be used as parts soldered to the + and − lead wires of the voice coil 110a. Accordingly, a soldering process between the voice coil 110a and the damper-lead plates 112 can be efficiently performed.

Existing connection between a voice coil and the terminal pole of a base frame was implemented by a process of soldering lead wires. In this case, a work process is problematic, and a phenomenon in which a lead wire is broken because the terminal pole of the base frame is fixed and a voice coil plate is moved up and down can be generated. The damper-lead plates 112 of the present invention can supplement the conventional problem.

As described above, the damper-lead plates 112 are configured to be connected to the voice coil plate 110 in the form of a sheet spring in such a way as to transfer more sound energy to the vibration plate 113, thereby being capable of improving the quality of the speaker. Furthermore, the damper-lead plates 112 are formed of metallic thin films, the terminals 203a and 203b are formed on both sides of the damper-lead plates 112, and the lead blocks 204a, 204b and 205a, 205b are formed at locations corresponding to the voice coil. Accordingly, the efficiency of a production process can be improved and quality can be maintained because a process of connecting the voice coil and the lead wires of the base frame is eliminated.

While preferred embodiments of the present invention have been described with reference to the accompanying drawings, those skilled in the art to which the present invention pertains will understand that the present invention may be implemented in other detailed forms without departing from the technical spirit or essential characteristics of the present invention. Accordingly, the aforementioned embodiments should not be construed as being limitative, but should be construed as being only illustrative from all aspects. Furthermore, the scope of the present invention is defined by the appended claims rather than the detailed description, and it should be understood that all modifications or variations derived from the meanings and scope of the present invention and equivalents thereof are included in the scope of the appended claims.

1. A flat type speaker having damper-lead plates for a PCB voice coil plate, comprising:
a pair of magnetic bodies spaced apart from each other at a specific interval, formed side by side, and each having a magnet and yorks formed therein;
a voice coil plate inserted into an interval between the magnetic bodies and having a voice coil spirally patterned and printed formed therein;
damper-lead plates comprising first and second damper-lead plates physically separated and having + and − terminals formed at respective front ends of the damper-lead plates, wherein each of the first and the second damper-lead plates comprises a coil plate spline adhered to a top of the voice coil plate and one or more wing splines having one end connected to the coil plate spline and the other end connected to the + or − terminal; and
a vibration plate vibrated in response to a vibration of the voice coil plate with the vibration plate coming in contact with a top of the damper-lead plates.

2. The flat type speaker of claim 1, wherein the wing splines are brought in contact with a bottom of the vibration plate.

3. The flat type speaker of claim 1, wherein:
the first and the second damper-lead plates are made of conductive and metallic materials, and
the second damper-lead plate is symmetrical to the first damper-lead plate and rotated by 180 degrees from the first damper-lead plate.

4. The flat type speaker of claim 1, wherein:
the first and the second damper-lead plates are made of insulating materials and formed of one body, and
the first and the second damper-lead plates are coated with conductive materials in such a way as to be electrically separated.

5. The flat type speaker of claim 1, wherein each of the first and the second damper-lead plates comprises a lead block connected to a front end of the voice coil by soldering at a front end on one or the other side of the coil plate spline or at front ends on both sides of the coil plate spline.

6. The flat type speaker of claim 5, wherein:
a width of the coil plate spline is smaller than or equal to a thickness of the voice coil plate, and
a width of the lead block is greater than the width of the coil plate spline.
